(19) United States
(12) Patent Application Publication
(10) Pub. No.: US 2026/0131734 A1
(43) Pub. Date: May 14, 2026

(54) SYSTEMS AND METHODS FOR STEERING WHEEL-BASED CONTROL OF CAMERA MONITOR SYSTEM

(71) Applicant: STONERIDGE ELECTRONICS AB, Solna (SE)

(72) Inventors: Banuprakash Murthy, Novi, MI (US); Troy Cooprider, White Lake, MI (US); John Kirwan, Troy, MI (US)

(21) Appl. No.: 19/032,298

(22) Filed: Jan. 20, 2025

Related U.S. Application Data
(60) Provisional application No. 63/625,026, filed on Jan. 25, 2024.

(51) Int. Cl. B60R 1/28; B60K 35/10; B60R 1/26; B60S 1/56; B62D 1/04; B62D 1/08; H04N 7/18; H04N 23/62

(52) U.S. Cl. CPC B60R 1/28; B60K 35/10; B60R 1/26; B62D 1/046; H04N 7/183; H04N 23/62; B60K 2360/21; B60K 2360/349; B60R 2300/306; B60S 1/56; B62D 1/08

(57) ABSTRACT

A camera monitor system (CMS) for a vehicle includes a camera configured to record an image feed of an external environment of a vehicle; an electronic display configured to display at least a portion of the image feed; a steering wheel including at least one input device; and processing circuitry operatively connected to memory. The processing circuitry is configured to receive a command from the at least one input device and, based on the command, adjust what is shown on the electronic display, or activate a feature of the camera. A method for a camera monitor system (CMS) is also disclosed.

### CROSS REFERENCE TO RELATED APPLICATION

This application claims priority to U.S. Provisional Application No. 63/625,026 which was filed on Jan. 25, 2024, and is incorporated herein by reference in its entirety.

### TECHNICAL FIELD

This disclosure relates to a camera monitor system (CMS) and a steering wheel used to control various functions and features of the CMS.

### BACKGROUND

Mirror replacement systems, and camera systems for supplementing mirror views, are utilized in commercial vehicles to enhance the ability of a vehicle operator to see a surrounding environment. Camera monitor systems (CMS) utilize one or more cameras disposed about the vehicle to provide an enhanced field of view to a vehicle operator on one or more displays located in the vehicle cabin. In some examples, mirror replacement systems within the CMS can cover a larger field of view than a conventional mirror, or can include views that are not fully obtainable via a conventional mirror.

Controls such as buttons have been used on steering wheels in passenger cars and light duty trucks for quite some time. Those controls have generally been limited to non-safety related features, such as cruise control, radio controls, heated steering wheels and menus related to vehicle system information (e.g., fuel economy, oil life, trip odometer, tire pressure, etc.). Steering wheel-based controls have been used more recently on commercial trucks for such features as running light cut-off, Jake Brake, cruise control and radio control. Thus far, no steering wheel-based controls have been used for a CMS.

CMS have numerous features intended to enhance driver awareness and usability, including automatic panning, trailer end distance lines, and customizable views on the displays. It may be desirable for the driver to access and/or modify these features while operating the vehicle. In order to minimize driver distraction and enhance safety, it is important to provide the driver access in a quick, intuitive manner.

### SUMMARY

A camera monitor system (CMS) for a vehicle according to an example embodiment of the present disclosure includes a camera configured to record an image feed of an external environment of a vehicle; an electronic display configured to display at least a portion of the image feed; a steering wheel including at least one input device; and processing circuitry operatively connected to memory. The processing circuitry is configured to receive a command from the at least one input device and, based on the command, adjust what is shown on the electronic display, or activate a feature of the camera.

In a further embodiment of the foregoing embodiment, the at least one input device is a non-touchscreen input device.

In a further embodiment of any of the foregoing embodiments, the at least one input device includes at least one of a button, a dial, a paddle, a rocker switch, a joystick, a touch pad.

In a further embodiment of any of the foregoing embodiments, the steering wheel includes a central portion and a plurality of spokes extending outwards from the central portion, and the at least one input device is part of one or more of the plurality of spokes.

In a further embodiment of any of the foregoing embodiments, the steering wheel includes a central portion and a plurality of spokes extending outwards from the central portion, and the at least one input device is part of the central portion.

In a further embodiment of any of the foregoing embodiments, to adjust what is shown on the electronic display, the processing circuitry is configured to adjust a brightness or a zoom level of the image feed on the electronic display.

In a further embodiment of any of the foregoing embodiments, the camera faces rearward to include at least a portion of a trailer of the vehicle in the image feed, and to adjust what is shown on the electronic display, the processing circuitry is configured to pan the image feed on the electronic display.

In a further embodiment of any of the foregoing embodiments, to adjust what is shown on the electronic display, the processing circuitry is configured to turn the electronic display ON or OFF.

In a further embodiment of any of the foregoing embodiments, to adjust what is shown on the electronic display, the processing circuitry is configured to display a menu of the CMS.

In a further embodiment of any of the foregoing embodiments, the feature of the camera includes a debris clearance feature.

A method for a camera monitor system (CMS) according to an example embodiment of the present disclosure includes obtaining an image feed of an external environment of a vehicle from a camera; displaying at least a portion of the image feed on an electronic display; receiving a command from at least one input device that is part of a steering wheel of the vehicle; and, based on the command, adjusting what is shown on the electronic display, or activating a feature of the camera.

In a further embodiment of the foregoing embodiment, the at least one input device is a non-touchscreen input device, and the at least one input device includes at least one of a button, a dial, a paddle, a rocker switch, a joystick, or a touch pad.

In a further embodiment of any of the foregoing embodiments, the steering wheel includes a central portion and a plurality of spokes extending outwards from the central portion. The receiving a command from at least one input device that is part of a steering wheel of the vehicle includes receiving the command from at least one input device that is part of one or more of the plurality of spokes.

In a further embodiment of any of the foregoing embodiments, the steering wheel includes a central portion and a plurality of spokes extending outwards from the central portion. The receiving a command from at least one input device that is part of a steering wheel of the vehicle includes receiving the command from at least one input device that is part of the central portion.

In a further embodiment of any of the foregoing embodiments, the adjusting what is shown on the electronic display includes adjusting a brightness or zoom level of the image feed on the electronic display.

In a further embodiment of any of the foregoing embodiments, the camera faces rearward to include at least a portion of a trailer of the vehicle in the image feed, and the adjusting what is shown on the electronic display includes panning the image feed on the electronic display.

In a further embodiment of any of the foregoing embodiments, the adjusting what is shown on the electronic display includes turning the electronic display ON or OFF.

In a further embodiment of any of the foregoing embodiments, the adjusting what is shown on the electronic display includes displaying a menu of the CMS.

In a further embodiment of any of the foregoing embodiments, activating the feature of the camera includes activating a debris clearance feature of the camera.

A camera monitor system (CMS) for a vehicle according to an example embodiment of the present disclosure includes a camera configured to record an image feed of an external environment of a vehicle; an electronic display configured to display at least a portion of the image feed; a steering wheel including at least one input device; and processing circuitry operatively connected to memory. The processing circuitry is configured to receive a command from the at least one input device and, based on the command, how the image feed is depicted on the electronic display.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE DRAWINGS

The disclosure can be further understood by reference to the following detailed description when considered in connection with the accompanying drawings wherein:

FIG. 1A is a schematic front view of a commercial truck with a camera monitor system (CMS) used to provide at least Class II and Class IV views.

FIG. 1B is a schematic top elevational view of a commercial truck with a camera mirror system providing Class II, Class IV, Class V, Class VI and Class VIII views.

FIG. 2A is a schematic illustration of an interior of a vehicle cab and the CMS.

FIG. 2B is another view of the interior of the vehicle cab.

FIG. 3 is a schematic view of an example steering wheel used to control various functions of the CMS.

FIG. 4 is a flowchart of an example method for a CMS.

### DETAILED DESCRIPTION

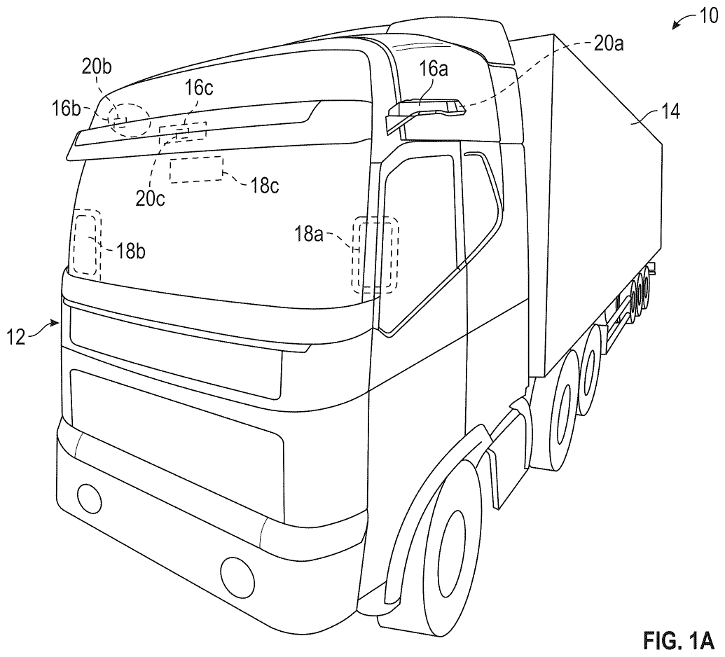

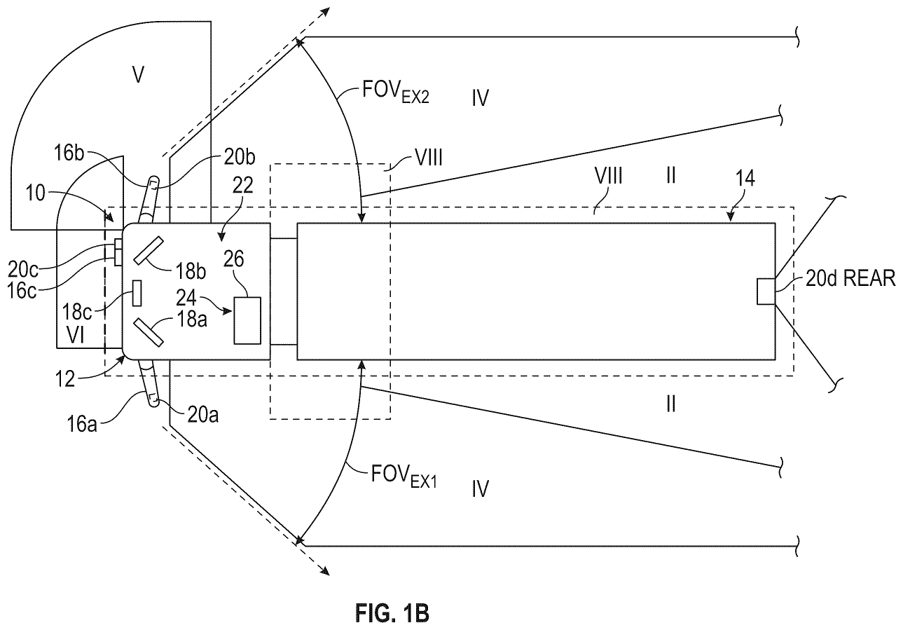

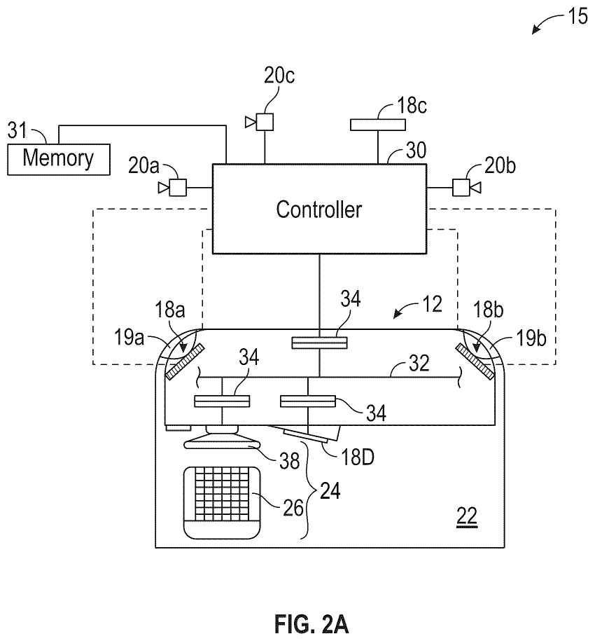

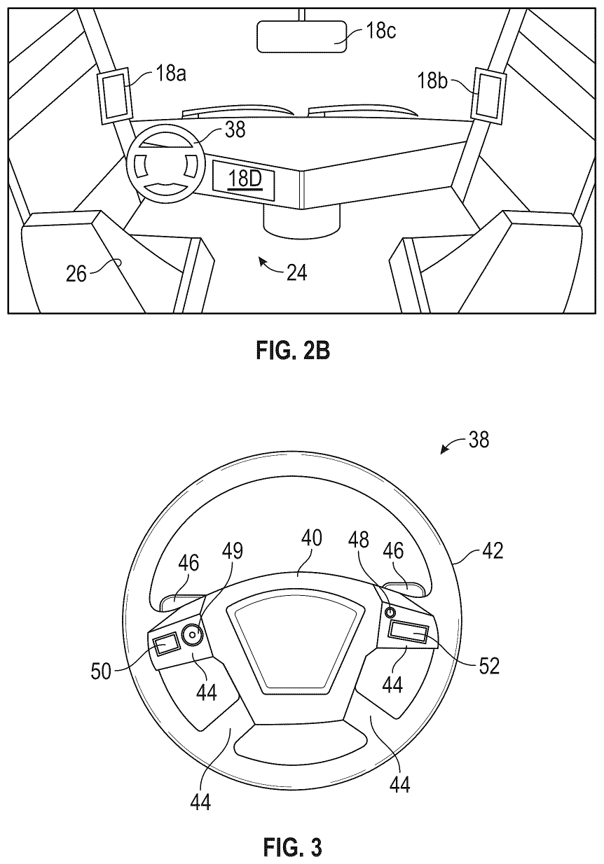

A schematic view of a commercial vehicle 10 is illustrated in FIGS. 1A and 1B. FIGS. 2A and 2B are respectively a schematic top schematic view and forward-facing perspective of the vehicle cabin 22 including displays and interior cameras. The vehicle 10 includes a vehicle cab or tractor 12 for pulling a trailer 14. It should be understood that the vehicle cab 12 and/or trailer 14 may be any configuration. Although a commercial truck is contemplated in this disclosure, the invention may also be applied to other types of vehicles. The vehicle 10 incorporates a camera monitor system (CMS) 15 (FIG. 2A) that has driver and passenger side camera arms 16a, 16b (generally, “camera arm 16” or “wing”) mounted to the outside of the vehicle cab 12. If desired, the camera arms 16a, 16b may include conventional mirrors integrated with them as well, although the CMS 15 can be used to entirely replace mirrors if desired. In additional examples, each side can include multiple camera arms, each arm housing one or more cameras and/or mirrors. In one such configuration, camera arms may be mounted to the trailer 14 at or near one or both of the front corners of the trailer 14.

Each of the camera arms 16a, 16b includes a base that is secured to, for example, the cab 12. A pivoting arm is supported by the base and may articulate relative thereto. Fixed wings may also be used. At least one rearward facing camera 20a, 20b is arranged respectively within camera arms. The exterior cameras 20a, 20b each have an image capture unit that capture an exterior field of view FOV_{EX1}, FOV_{EX2} that each include at least one of the Class II and Class IV views (FIG. 1B), which are legal prescribed views in the commercial trucking industry, and that each depict an external environment of the vehicle 10. It is desirable to capture at least a portion of the trailer 14 in the field of view, for example, the side and/or end of the trailer, throughout vehicle operation. Multiple cameras also may be used in each camera arm 16a, 16b to provide these views, if desired. Class II and Class IV views are defined in European R46 legislation, for example, and the United States and other countries have similar drive visibility requirements for commercial trucks. Any reference to a “Class” view is not intended to be limiting, but is intended as exemplary for the type of view provided to a display by a particular camera. Each arm 16a, 16b may also provide a housing that encloses electronics that are configured to provide various features of the CMS 15.

As shown in FIGS. 2A-B, first and second video displays 18a, 18b are arranged on each of the driver and passenger sides within the vehicle cab 12 on or near the A-pillars 19a, 19b to display Class II (narrow angle view) and/or Class IV (wide angle view) views (e.g., Class II depicted above Class IV in a portrait-style configuration) on its respective side of the vehicle 10, which provide rear facing side views along the vehicle 10 (e.g., portions of the trailer 14) of image feeds that are captured by the exterior cameras 20a, 20b.

If video of Class V and/or Class VI views are also desired, a camera housing 16c and camera 20c may be arranged at or near the front of the vehicle 10 to provide those views (FIG. 1B). A third display 18c arranged within the cab 12 near the top center of the windshield can be used to display the Class V and Class VI views, which are toward the front of the vehicle 10, to the driver. Other displays may be arranged in the cabin 22, such as display 18D (FIGS. 2A and 2B). It should be understood that an additional or different number of displays may be used than illustrated. The displays 18a, 18b, 18c, 18d face a driver region 24 within the cabin 22 where an operator is seated on a driver seat 26. The location, size and field(s) of view streamed to any particular display may vary from the configurations described in this disclosure and still incorporate the disclosed invention.

If video of Class VIII views is desired, camera housings can be disposed at the sides and rear of the vehicle 10 to provide fields of view including some or all of the Class VIII zones of the vehicle 10. As illustrated, the Class VIII view includes views immediately surrounding the trailer, and in the rear proximity of the vehicle including the rear of the trailer. In one example, a view of the rear proximity of the vehicle is generated by a rear facing camera 20d disposed at the rear of the vehicle, and can include both the immediate rear proximity and a traditional rear view (e.g. a view extending rearward to the horizon, as may be generated by a rear view mirror in vehicles without a trailer). In such examples, the third display 18c can include one or more frames displaying the Class VIII views. Alternatively, additional displays can be added near the displays 18a, 18b, 18c and/or display 18d (generally, “display 18”) and provide a display dedicated to providing a Class VIII view.

In some cases, the Class VIII view is generated using a trailer mounted camera 20d. The trailer mounted camera 20d is a rear facing camera which provides a field of view behind the trailer. This rear view can be provided to one of the displays 18a, 18b and/or another display 18c or 18d within the vehicle cabin 22 as a rear view mirror replacement or as a rear view mirror supplement. This view is particularly beneficial as the trailer 14 may block some, or all, views provided by a conventional rear view mirror.

In one or more embodiments, the CMS 15 is also configured to utilize the images from the cameras 20a, 20b, 20c, 20d (generally, “camera 20”) as well as images from other cameras that may be disposed about the vehicle or in communication with the vehicle to determine features of the vehicle, identify objects, and facilitate driver assistance features such as display overlays and semi-automated driver assistance systems.

These features and functions of the CMS 15 are used to implement multiple CMS 15 features that aid in operation of the vehicle 10. It should be noted that a controller 30 (FIG. 2A) for the CMS 15 can be used to implement the various functionalities disclosed in this application. The controller 30, which is in communication with the displays 18 and cameras 20, may include one or more discrete units. For example, a centralized architecture may have a common controller arranged in the vehicle 10, while a decentralized architecture may use a controller provided in each of the displays 18, for example. Moreover, a portion of the controller 30 may be provided in the vehicle 10, while another portion of the controller 30 may be located elsewhere, for example, the camera arms 16. In another example, a master-slave display configuration may be used where one display includes the controller 30 while the other display receives the commands from the controller 30.

In terms of hardware architecture, such a controller can include a processor, memory (e.g., memory 31, FIG. 2A), and one or more input and/or output (I/O) device interface(s) that are communicatively coupled via a local interface. The local interface can include, for example but not limited to, one or more buses and/or other wired or wireless connections. The local interface may have additional elements, which are omitted for simplicity, such as controllers, buffers (caches), drivers, repeaters, and receivers to enable communications. Further, the local interface may include address, control, and/or data connections to enable appropriate communications among the aforementioned components.

The controller 30 is a hardware device and may be configured for executing software, particularly software stored in memory (e.g., memory 31, FIG. 2A). The controller 30 includes processing circuitry (e.g., a custom made or commercially available processor, a central processing unit (CPU), an auxiliary processor among several processors associated with the controller, a semiconductor-based microprocessor (in the form of a microchip or chip set), a microcontroller, an application specific integrated circuit, or generally any device for executing software instructions).

The memory 31 can include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). Moreover, the memory 31 may incorporate electronic, magnetic, optical, and/or other types of storage media. The memory 31 can also have a distributed architecture, where various components are situated remotely from one another, but can be accessed by the processor.

The software in the memory 31 may include one or more separate programs, each of which includes an ordered listing of executable instructions for implementing logical functions. A system component embodied as software may also be construed as a source program, executable program (object code), script, or any other entity comprising a set of instructions to be performed. When constructed as a source program, the program is translated via a compiler, assembler, interpreter, or the like, which may or may not be included within the memory 31.

The disclosed input and output devices that may be coupled to system I/O interface(s) may include input devices, for example but not limited to, touch screens, and various non-touchscreen input devices (e.g., buttons, dials, paddles, rocker switches, joysticks, touch pads, etc.

The processing circuitry can be configured to, when the controller 30 is in operation, execute software stored within the memory 31, to communicate data to and from the memory 31, and to generally control operations of the CMS 15 pursuant to the software. Software in memory 31, in whole or in part, is read by the processing circuitry, perhaps buffered within the processor, and then executed.

Referring to FIG. 2A,, the vehicle 10 includes a CAN bus 32 having various connections 34. The CAN bus 32 communicates vehicle data from various controllers on the vehicle 10 so that information can be shared. The controller 30 of the CMS 15 may be connected to CAN bus 32 by one of the connections 34. In one disclosed example, the vehicle's steering wheel 38 is also connected to the CAN bus 32 to enable communications between the CMS 15 and at least one input device provided on the steering wheel 38.

An example steering wheel 38 is shown in FIG. 3 and includes a central portion 40 connected to a peripheral portion 42 by spokes 44 that extend outwards from the central portion 40. The input devices provided on the steering wheel 38 may include one or more paddles 46, single-or multi-action buttons 48, 49, scrolling dials 50 (push or non-push), and/or swipe pads 52. For example, a swipe pad may be used for multiple views like providing a panoramic view, a stitched view, a Class IV view across entire monitor, or a Class II view across an entire display. As used herein, a touch pad is not a touchscreen because the touchpad is itself not a display.

Although the input devices may be arranged on the spokes 44, they make also be provided on the central portion 40, as some commercial vehicles do not have an airbag, although the vehicle's city horn is typically provided on the central portion 40. Additional or different input devices may be used (e.g., rocker switches and/or joysticks), and those devices may be arranged in a manner to provide quick intuitive access to the driver.

The input devices are configured to communicate with the controller 30 to provide access to CMS feature modules in order to enable the driver to quickly and easily modify one or more system features. It is desirable to design the input device and its modification to the system feature such that the driver can limit the interaction to 250 ms or less, which affords the driver more time reaction time to respond to the vehicle's surroundings. Having the driver reach for buttons or touch screen displays (HMI) farther away is more time consuming and safety averse while driving at high speeds. Having controls right on steering wheel 38 eases the HMI operations for the CMS 15.

In one example, the feature module is a panning system module, which provides functionality relating to the CMS feature of panning. Panning is used keep the trailer end in view of the driver by, for example, cropping a different portion of an image feed of captured images in response to the trailer angle. Otherwise, the display would show the side of the trailer (like a conventional mirror would), which is not particularly useful to the driver. In one example panning system module, the default mode of operation is automatic panning in response to steering angle. Some drivers may not wish to automatically pan, or may wish to avoid this feature in certain scenarios. To this end, one of the steering wheel input devices (e.g., the single-action button 48) may be used by the driver to toggle between ON/OFF states for automatic panning. The driver may still be able to manually pan the displayed view in one or both of the ON/OFF states (e.g., using one or more of the input devices). In one or more of the embodiments, actuation of one of the input devices resets to a default viewing configuration (e.g., to undo zooming and/or undo panning, and/or to implement a standard configuration in which a Class II view is depicted above a Class IV view). In one or more embodiments, the reset is initiated based on a single button press (e.g., without requiring a press and hold).

In another example, the feature module is a zoom system module, and the system feature is adjusting a zoom level of one of the image feeds (e.g., zooming in on an object or feature in an image feed of captured images, such as the trailer 14 end or trailer wheels). The driver may wish to quickly employ this feature in a high traffic or tight access area, for example, when driving in reverse. In one example, a push scrolling dial 50 may be provided on each of left-and right-hand spokes 44 corresponding to left-and right-hand rear-facing camera views. The driver can push the scrolling dial 50 on the side for which a zoomed view is desired, and then roll the dial upward to zoom in on the view. Conversely, rolling the dial downward zooms the view back out. Pushing the scrolling dial 50 may restore the non-zoomed view. This feature can be integrated with manual panning by, for example, providing a multi-action button 49 in which pushing the button activates and deactivates the panning and zooming functions, up/down zooms in and out, and left/right pans left and right. Of course, there are other variations to controls that may be used for these system features.

In another example, the feature module is a camera debris mitigation module, which may control system features such as camera lens debris clearance (e.g., wiping, blowing and/or deicing). A button 48 may be used to activate a heater to defrost the lens and/or wipe the camera lens to remove debris.

In another example, the feature module is a display module, and the system feature is display brightness. The displays 18a, 18b in particular may become washed out or appear dim due to changing ambient lighting conditions, for example. Thus, it may be desirable for the driver to temporarily adjust the display brightness in response to input, such as a push scrolling dial 50. The dial 50 can be pushed to activate the screen's brightness control, and the dial 50 rolled up/down to increase/decrease brightness. Multiple pushes of the dial 50 may be used to select one of the displays for brightness adjustment independently of the other displays. Input device(s) may be provided on the steering wheel 38 for controlling additional image processing to mitigate undesired effects of direct sun glare on the camera or brightness control due to in-tunnel out-of-tunnel types of scenarios.

In another example, the feature module is a driver awareness module relating to system features such as warnings and graphical overlays (e.g., trailer end distance lines, trailer path, jack-knife warning, collision warning, etc.). The input device can be used to navigate menus that enable the driver to customize the awareness features (e.g., display preferences for warnings and/or overlays, sensitivity in triggering a warning) or simply turn the feature ON/OFF to manage which awareness features are used so that the driver is not overwhelmed with displayed graphics or annoying warnings.

In another example, the feature module is a displayed view module, relating to system features such as display preferences (e.g., preferences for location of displayed views). The input device can be used to navigate menus that enable the driver to customize the driver's display preferences.

For fleet management, event recording (storing vehicle data on a DVR or sent to the cloud) can be triggered using steering wheel buttons, if desired. Steering wheel controls may also be provided for trailer-based sensors and functionality (e.g., trailer cameras, trailer ultrasonic sensors, trailer door sensors, trailer height warnings, etc.) when integrated into the CMS 15. For example, the steering wheel input devices can accessing state of health of load in the trailer on a secondary monitor or rear view.

For other CMS features like trailer cabin camera, cameras on the front edge of trailer for elimination blind spots while turning, etc., the steering wheel input devices can easily enable additional or change between views. The back side of the steering wheel 38 may also include input devices for short cuts like default displayed views, previous views, or any other CMS control.

If desired, the input devices on the steering wheel 38 may be identified by a different color, symbol or label than any non-CMS-related input device. Such distinguishing identification will further improve the driver's ability to quickly identify CMS controls, particularly when not familiar with the vehicle. Use of the input devices may initiate a menu, indicator and/or overlay on one or more displays to give visual confirmation to the driver of the system feature being accessed in response to the driver's input and/or bring up a menu on a driver information system (e.g., on instrument panel) as a tool for navigating options.

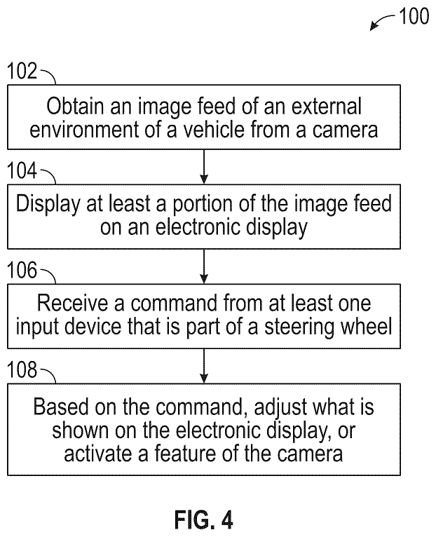

FIG. 4 is a flowchart of an example method 100 for a CMS. An image feed of an external environment of vehicle 10 is obtained from a camera 20 (step 102), which may be a rearward-facing camera (e.g., with the captured image depicting a field of view including at least a portion of trailer 14 of the vehicle 10). At least a portion of the image feed is displayed on an electronic display 18 (step 104).

A command is received from at least one input device that is part of a steering wheel 38 of the vehicle 10 (step 106). Based on the command, what is shown on the electronic display 18 is adjusted, or activating a feature of the camera is activated (step 108). As discussed above, various input devices could be used, and various actions could be performed in step 108 (e.g., panning, zooming, toggling ON/OFF, initiating a debris clearance feature, etc.).

It should also be understood that although a particular component arrangement is disclosed in the illustrated embodiment, other arrangements will benefit herefrom. Although particular step sequences are shown, described, and claimed, it should be understood that steps may be performed in any order, separated or combined unless otherwise indicated and will still benefit from the present invention.

Although the different examples have specific components shown in the illustrations, embodiments of this invention are not limited to those particular combinations. It is possible to use some of the components or features from one of the examples in combination with features or components from another one of the examples, and that none of the specific input devices mentioned above are limited to the example feature they were discussed in connection with.

Although an example embodiment has been disclosed, a worker of ordinary skill in this art would recognize that certain modifications would come within the scope of the claims. For that reason, the following claims should be studied to determine their true scope and content.

What is claimed is:

1. A camera monitor system (CMS) for a vehicle, comprising:
a camera configured to record an image feed of an external environment of a vehicle;
an electronic display configured to display at least a portion of the image feed;
a steering wheel including at least one input device; and
processing circuitry operatively connected to memory, and configured to:
receive a command from the at least one input device; and
based on the command, adjust what is shown on the electronic display, or activate a feature of the camera.

2. The CMS of claim 1, wherein the at least one input device is a non-touchscreen input device.

3. The CMS of claim 2, wherein the at least one input device includes at least one of a button, a dial, a paddle, a rocker switch, a joystick, a touch pad.

4. The CMS of claim 1, wherein the steering wheel comprises a central portion and a plurality of spokes extending outwards from the central portion, and the at least one input device is part of one or more of the plurality of spokes.

5. The CMS of claim 1, wherein the steering wheel comprises a central portion and a plurality of spokes extending outwards from the central portion, and the at least one input device is part of the central portion.

6. The CMS of claim 1, wherein to adjust what is shown on the electronic display, the processing circuitry is configured to adjust a brightness or a zoom level of the image feed on the electronic display.

7. The CMS of claim 1, wherein:
the camera faces rearward to include at least a portion of a trailer of the vehicle in the image feed, and
to adjust what is shown on the electronic display, the processing circuitry is configured to pan the image feed on the electronic display.

8. The CMS of claim 1, wherein to adjust what is shown on the electronic display, the processing circuitry is configured to turn the electronic display ON or OFF.

9. The CMS of claim 1, wherein to adjust what is shown on the electronic display, the processing circuitry is configured to display a menu of the CMS.

10. The CMS of claim 1, wherein the feature of the camera comprises a debris clearance feature.

11. A method for a camera monitor system (CMS), comprising:
obtaining an image feed of an external environment of a vehicle from a camera;
displaying at least a portion of the image feed on an electronic display;
receiving a command from at least one input device that is part of a steering wheel of the vehicle; and
based on the command, adjusting what is shown on the electronic display, or activating a feature of the camera.

12. The method of claim 11, wherein the at least one input device is a non-touchscreen input device, and wherein the at least one input device includes at least one of a button, a dial, a paddle, a rocker switch, a joystick, or a touch pad.

13. The method of claim 11, wherein:
the steering wheel comprises a central portion and a plurality of spokes extending outwards from the central portion; and
said receiving a command from at least one input device that is part of a steering wheel of the vehicle comprises receiving the command from at least one input device that is part of one or more of the plurality of spokes.

14. The method of claim 11, wherein:
the steering wheel comprises a central portion and a plurality of spokes extending outwards from the central portion; and
said receiving a command from at least one input device that is part of a steering wheel of the vehicle comprises receiving the command from at least one input device that is part of the central portion.

15. The method of claim 11, wherein said adjusting what is shown on the electronic display comprises adjusting a brightness or zoom level of the image feed on the electronic display.

16. The method of claim 11, wherein:
the camera faces rearward to include at least a portion of a trailer of the vehicle in the image feed; and
said adjusting what is shown on the electronic display comprises panning the image feed on the electronic display.

17. The method of claim 11, wherein said adjusting what is shown on the electronic display comprises turning the electronic display ON or OFF.

18. The method of claim 11, wherein said adjusting what is shown on the electronic display comprises displaying a menu of the CMS.

19. The method of claim 11, wherein activating the feature of the camera comprises activating a debris clearance feature of the camera.

20. A camera monitor system (CMS) for a vehicle, comprising:
a camera configured to record an image feed of an external environment of a vehicle;
an electronic display configured to display at least a portion of the image feed;
a steering wheel including at least one input device; and
processing circuitry operatively connected to memory, and configured to:
receive a command from the at least one input device; and
based on the command, how the image feed is depicted on the electronic display.
